(19) United States
(12) Patent Application Publication
(10) Pub. No.: US 2018/0293596 A1
(43) Pub. Date: Oct. 11, 2018

(54) SHELF IMAGE RECOGNITION ANALYTICS

(71) Applicant: International Business Machines Corporation, Armonk, NY (US)

(72) Inventors: Ben Z. Akselrod, Givat Shmuel (IL); Anthony Di Loreto, Markham (CA); Steve McDuff, Markham (CA); Kyle D. Robeson, North York (CA)

(21) Appl. No.: 15/483,369

(22) Filed: Apr. 10, 2017

(51) Int. Cl. G06Q 30/02; G06K 9/62; G06Q 10/06

(52) U.S. Cl. CPC G06Q 30/0201; G06T 7/60; G06Q 10/06315; G06K 9/6267

(57) ABSTRACT

A method, system and computer program product are disclosed for analyzing a performance of a display in a retail venue using image recognition analytics. In an embodiment, the method comprises capturing an image of the display; analyzing the image against a defined set of image attributes; generating a display classification for the display based on said analyzing; and extracting information about a specified performance of the display using the display classification and an image analytics system. In embodiments of the invention, specified products are held for sale on the display, and the extracting information about the performance of the display includes extracting information about the sales of the specified products on the display. In embodiments of the invention, the extracting information about the sales of the specified products on the display includes correlating sales of the specified products with one or more of the image attributes.

### BACKGROUND

This invention generally relates to analyzing shelves used for retail sale, and more specifically, to extracting insights to the performance or importance of shelves in retail venues.

It is well understood that the location and appearance of a shelf in a retail venue are very important factors that can directly and significantly affect the sales potential of products displayed on the shelf.

In a commercial brick and mortar environment, product placement on store shelves is critical to a retailer's success. Thus, one of the most important, or hottest, real estate markets in the country is on a retailer's store shelves. Experience has shown that products displayed at eye level sell better than products displayed on bottom shelves, and products placed on end-caps typically sell better than the same or similar items placed in the middle of an aisle.

This knowledge can be advantageous to both vendors and retailers. As an example, for vendors, it is beneficial to know which products are more or less placement sensitive. For retailers, determining areas, or hotspots, in shelf space that significantly affect sales of products enables retailers to extract a premium in negotiations with the vendor over use of those shelf areas.

### SUMMARY

Embodiments of the invention provide a method, system and computer program product for analyzing a performance of a display in a retail venue using image recognition analytics. In one embodiment, the method comprises capturing an image of the display; analyzing the image of the display against a defined set of image attributes; generating a display classification for the display based on said analyzing; and extracting information about a specified performance of the display using the display classification and an image analytics system.

In embodiments of the invention, specified products are held for sale on the display, and the extracting information about a specified performance of the display includes extracting information about the sales of the specified products on the display.

Embodiments of the invention visually capture a store display image temporally, analyze the display image against a defined set of image attributes (e.g., quality tags), apply analytics against the set of image attributes extracted from the image and a display attribute sales and conversion database, and generate a display classification which is then fed to an analytics system to extract insights between the shelves and the performance of the store or to the performance of the shelves themselves.

### BRIEF DESCRIPTION OF THE SEVERAL VIEWS OF THE DRAWINGS

FIG. 1 shows a rack of shelves in a retail venue.

FIG. 2 illustrates a method and system in accordance with an embodiment of the invention.

FIG. 3 shows a computer network environment that may be used in embodiments of the invention

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

This invention generally relates to analyzing shelves used for retail sales, and more specifically, to extracting insights to the importance, or performance, of shelves in retail venues. The appearance and location of shelves impacts the sales rate (or conversion) of products. In embodiments of the invention, the results of the display analysis recommends what products to put on the shelves or in particular locations on shelves, or improvements to the shelving area that would boost sales. A display, as used herein, is a structure on which products are temporarily stored and displayed for customers. For example, the display is a shelf of a shelving unit in a venue.

As mentioned above, the location and appearance of a display in a retail venue are factors that can directly affect the sales potential of products displayed on the display.

In a commercial brick and mortar environment, product placement on store shelves can affect the sales and overall performance of a retailer. Thus, space, or particular spaces on, a retailer's store shelves are often viewed as a type of real estate that are in high demand. In some scenarios, certain products displayed at eye level sell better than products displayed on bottom shelves, and products placed on end-caps typically sell better than the same or similar items placed in the middle of an aisle.

This knowledge can be advantageous to both vendors and retailers. As an example, in certain scenarios, it is beneficial for vendors to know which products are more or less placement sensitive. Therefore, in some scenarios, placement sensitive areas, i.e., hotspots, in display space that significantly affect sales of products can be leveraged by retailers to extract a premium in negotiations with the vendor for the use of those display areas. As products are moved around the shelving area, the conversion rates of different spots on the shelves can be compared. The areas of the shelves that have the highest conversion rates, regardless of what products are there, would be these placement sensitive areas.

Embodiments of the invention provide a method, system and computer program product for analyzing a performance of a display in a retail venue using image recognition analytics. In one embodiment, the method comprises capturing an image of the display; analyzing the image of the display against a defined set of image attributes; generating a display classification for the display based on said analyzing; and extracting information about a specified performance of the display using the display classification and an image analytics system.

Analytics may also be applied across multiple venues, i.e., for a chain store. This would provide additional data that can be utilized for more accurate predictions. In embodiments of the invention, the data used in the analysis leads to the generation of profiles with specific attributes included for both the products and the shelves. The profiles may be generated based on the analytics, and the profiles can then be compared/leveraged to generate a best fit for the products and shelving options in the venue. For example, shelves have a rating associated with each type of light level in a range of light levels. Each product has a rating for the different types of shelves. Shelves and products have ratings for various heights. Products also have ratings for being adjacent to certain other products. All of that is leveraged to determine the best fit for not only the display but also the products on the display, lighting level, etc., and any promotional material attached to the display. A floor plan of the venue may then be generated based on this best fit.

In embodiments of the invention, specified products are held for sale on the display, and the extracting information about a specified performance of the display includes extracting information about the sales of the specified products on the display.

In practice, the shelves can be located or arranged in many different ways, and shelves may differ from each other in many ways. For instance, different shelves may be at different heights or locations in a store. The shelves may be lit in different ways or at different intensity levels. Different products may be displayed on different shelves, or the products may be displayed in different ways on a display. Promotional notices or displays may be shown on a display. The sales of the items on a display may differ from week to week, from day to day, and may depend on the time of day.

Certain shelves may have internal lighting. A higher display may provide overhead lighting for the products on the next display down, or lighting may be included in a display, like embedded track lighting, and shined up at the display above. A display may have a mirrored bottom such that the overall lighting level for products on the display is more uniform. These lighting factors may be analyzed and leveraged to help determine the “best fit” retail environment for the product. In embodiments of the invention, the image analysis may not be concerned with where the light is coming from, just how well lit the product is on the display.

Products may be lit using conventional over head lighting, spot lights, focus lighting or lights of different colors. Products can be displayed forward facing, sideways (like books in a bookcase), the labels on the products can be twisted, or the products can be leaned to allow the average shopper to see them better (like magazines in a magazine rack).

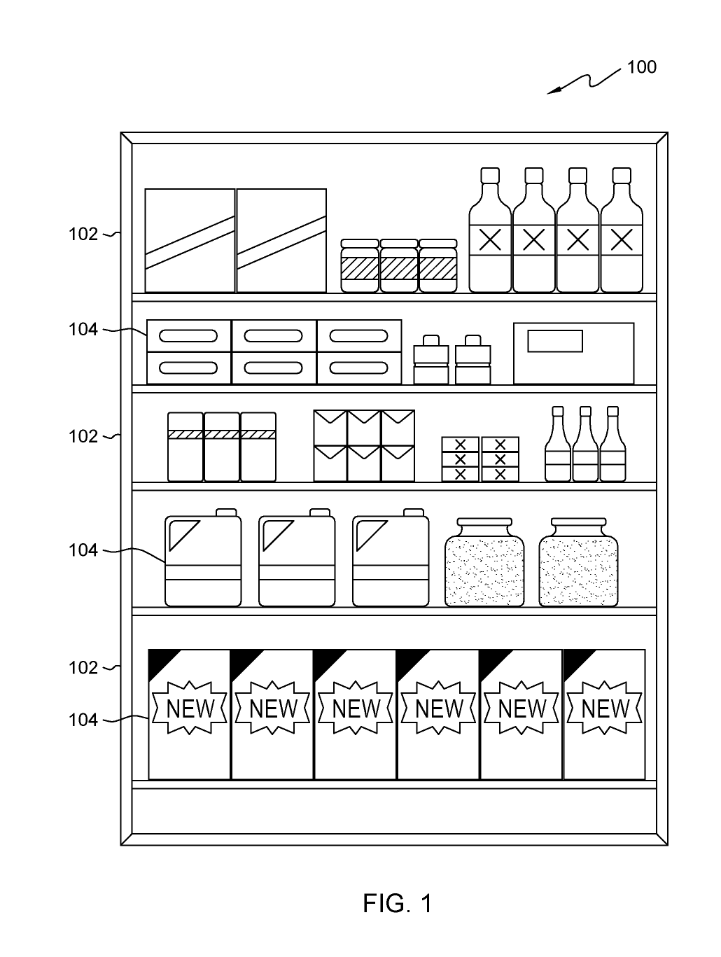

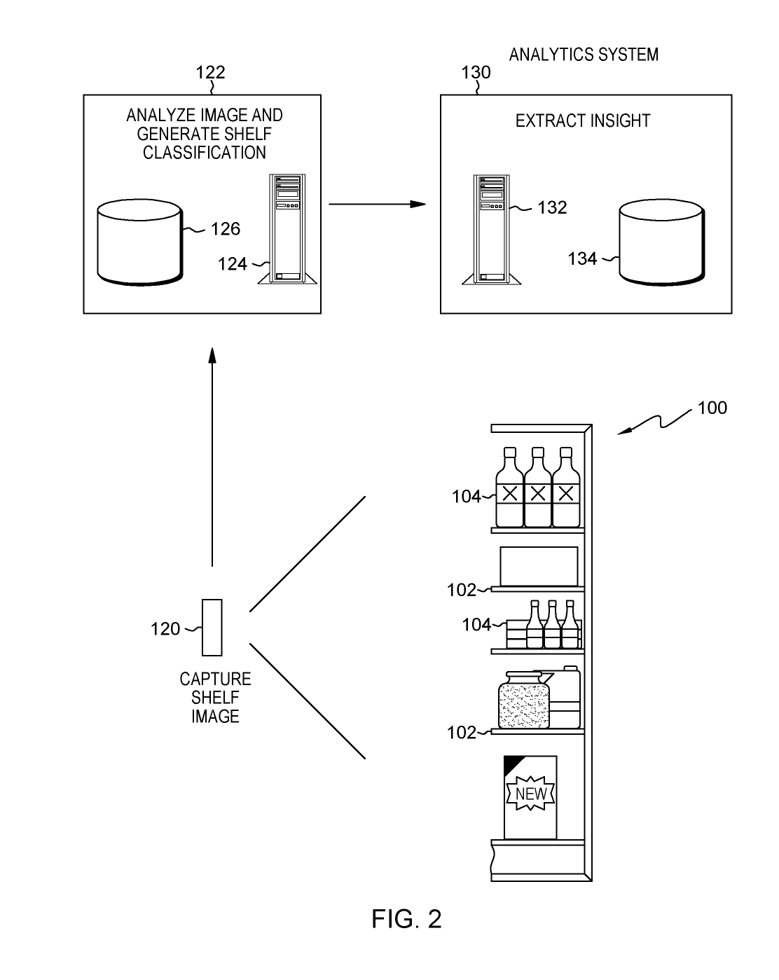

FIG. 1 shows, for example, a rack 100 of shelves 102. As can be seen, the shelves are at different heights, hold different products 104, and have different appearances. FIG. 2 illustrates a method and system for analyzing a display image.

With reference to FIGS. 1 and 2, embodiments of the invention visually capture a store display image temporally, analyze the display image against a defined set of image attributes (e.g., quality tags), apply analytics against the set of image attributes extracted from the image and a display attribute sales and conversion database, and generate a display classification which is then fed to an analytics system to extract insights between the shelves and the performance of the store or to the performance of the shelves themselves.

In embodiments of the invention, a store may have its own profile. This profile could also take or reflect floor plan differences between a particular store and a group of similar stores. For example, a particular class of retail stores may perform best with shelves with X, Y and Z properties. This information could then be leveraged in combination with the shelving and product profiles when determining the “best fit” for that venue. For an example embodiment, certain characteristics can be given greater weight when making a determination of a best fit. That way, the differences between the profiles of shelves, products, and venues can be resolved. Stores may have variable shelves throughout their location with different characteristics. This may be part of a store's profile.

Once the image has been analyzed for the various display attributes, the results of the image analysis are run through an analytic engine to create a value for that display space as per the product that is on the display. These values are correlated with the sales and transactions at the store for these particular products. As various display attributes change, these changes, or their corresponding rates of change, are fed into the analytics engine which deduces which attributes are affecting sales the most. In time, this provides a feedback loop which will show which products sell the best on which display space, and with what particular attributes in place. In time, the analytics system can provide insight to help sales at the store by making suggestions on how to improve which display attribute to help sell products.

For example, a first product, Product A, may be on a display with a particular light level 4/10, and the product sells one hundred units over the course of a week. The next week the product is moved to another display with a 6/10 light rating, and now sells one hundred fifty units in the same time period. The third week, the product is moved and it is in a light location with a 8/10 light level, but the product still only sells one hundred fifty units. Over time, it is determined that Product A sells the same in lighted levels 6/10 and up. Product A is then placed back on a display with a light level of only 4/10,. The system analyzes the display, and rather than suggest moving the product, the system suggests that the light level at that location should be raised to 6/10 in order to sell more of this product.

The display attribute sales and conversion database is a database which stores information on what display characteristics have been set for which products, how those characteristics have impacted sales, the current and history of the selling of those products, and the current understanding of how each display's attributes impact converting products into sales.

Any suitable image capture device 120 may be used to capture the image of the shelves. For instance, a suitable camera, or a computing device or mobile device having image capturing capabilities may be used. The image device generates data representing the captured image and transmits that data to image analyzer 122.

The image analyzer 122 may include any suitable computing device 124 that receives the image data from device 120 and processes that data according to an analysis program. Shelf attribute sales and conversion data are stored in database 126, and analyzer 124 accesses and uses that data in the analysis of the display image. The image analyzer generates a display classification that is fed to analytics system 130.

Analytics system 130, which may comprise a computing device 132 and a database 134, extracts information about the performance of the shelves using the display classification received from image analyzer 122. Any suitable analytics system may be used in embodiments of the invention. For example, display performance may be measured by how many products are sold from that area, and the analytics system 130 may be used to extract this information from the database 134. Other information that may be extracted may be, for instance, the amount of profit made from that display, as different products will have different profitability.

In embodiments of the invention, sample attributes include:
a. Shelf lighting level;
b. Shelf stock levels;
c. Shelf tidiness level (scan images and/or three-dimensional scan of the display to find out if products are placed in an orderly fashion, at the same angle, with the same image facing customers, etc.);
d. Shelf texture (metallic, wooden, polished, shiny);
e. Shelf promotional material density (how many promotion tags are showing on the display).

These attributes are fed to an analytics system to extract insights between the shelves and the performance of the display or the store. For example, as indicated above, information that may be extracted may include the number of products sold from a display, or the amount of profits made from the display. Also, for instance, the analytic system may determine that different shelves in the store were able to sell more versions of product A than other shelves. The analytics system may also show an example where the light level is determined to be a driving factor for converting sales.

Embodiments of the invention assign each display a rating based upon many factors such as light level, display composition, and display texture. This rating can be used to ensure the store is optimizing what products are on the display, to guarantee that the retail venue is meeting a contractual obligation, or to ensure that the shelves are meeting the retail venue's self-imposed standard.

For example, with this invention, after gathering data on display lighting, a store could run reports that show which brightness level brings the best level of sales and correlate that to the time of day. For instance, it may be the case that shelves exposed to the sun may be too bright mid day, but in the evenings, products on the shelves sell better. For example, if the shelves also provide lighting, this data can be leveraged to control the lighting level. Also, for instance, if it is known that a display is being illuminated too brightly by the sun, other lighting for the display could be lowered. Overhead lighting in the ceiling could also be changed. Usually, there is a minimum amount of lighting required for overall store lighting based on government regulations. This minimum amount of lighting can be accounted for as a lowest point in an acceptable lighting level range. In embodiments of the invention, lighting data could be fed into the analytics system to have dynamic control of the display lighting. This control could be either triggered based upon the light level in the store, or programmed based upon historical data.

As another example, retailers could correlate the amount of products on a particular display that are sold to the number of publicity and rebate notices on the display. Embodiments of the invention can be used to correlate how much shelves made of polished wood perform compared to shelves made of metal. As another example, embodiments of this invention can be used to determine if shelves that are in disarray impact product sales to determine when a restocking of a display should be triggered to maximize sales. Embodiments of the invention may be leveraged to trigger other events. Also, if a display/product combination is performing below a predicted level, the analytics system, in an embodiment of this invention could predict an alternative arrangement/combination to reduce the disparity. In an embodiment of the invention, if the analytics system is used to output a floor plan, data about seasonal products might be used to that, for example, the system might recommend summer items in a clearance section, regardless of how those items sell, in December.

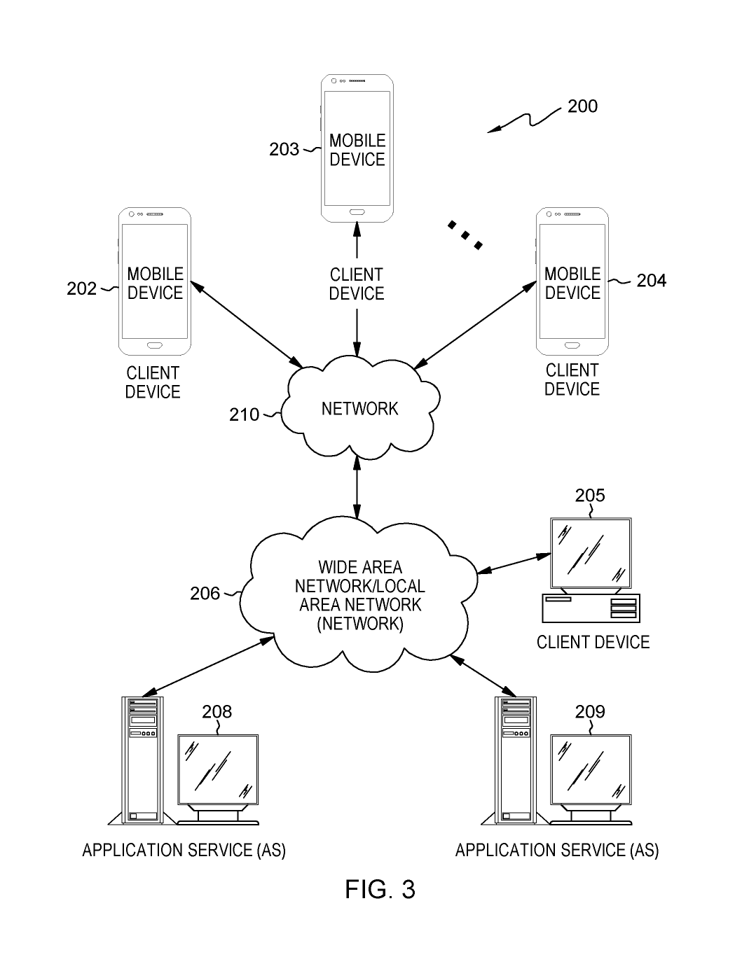

FIG. 3 shows components of an exemplary computer network environment 200 that may be used in embodiments of the invention. Not all the illustrated components may be required to practice the invention, and variations in the arrangement and type of the components may be made without departing from the spirit or scope of the invention. As shown, system 200 of FIG. 7 includes local area networks (“LANs”)/wide area network 206, wireless network 210, mobile devices 202-204, client device 205, and application services (AS) 208-209.

Generally, mobile devices 202-204 may include virtually any portable computing device that is capable of receiving and sending a message over a network, such as networks 206 and wireless network 210. Such devices include portable devices, such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 202-204 typically range widely in terms of capabilities and features.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device

Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 202-204 may each receive messages sent from AS 208-209, from one of the other mobile devices 202-204, or even from another computing device. Mobile devices 202-204 may also send messages to one of AS 208-209, to other mobile devices, or to client device 205, or the like. Mobile devices 202-204 may also communicate with non-mobile client devices, such as client device 205, or the like.

Wireless network 210 is configured to couple mobile devices 202-204 and its components with network 206. Wireless network 210 may include any of a variety of wireless sub-networks that may further overlay stand-alone ad-hoc networks, and the like, to provide an infrastructure-oriented connection for mobile devices 202-204. Such sub-networks may include mesh networks, Wireless LAN (WLAN) networks, cellular networks, and the like.

Network 206 is enabled to employ any form of computer readable media for communicating information from one electronic device to another. Also, network 206 can include the Internet in addition to local area networks (LANs), wide area networks (WANs), direct connections, such as through a universal serial bus (USB) port, other forms of computer-readable media, or any combination thereof.

AS 208-209 include virtually any device that may be configured to provide an application service. Such application services or simply applications include, but are not limited to, email applications, search applications, video applications, audio applications, graphic applications, social networking applications, text message applications, or the like. In one embodiment, AS 208-209 may operate as a web server. However, AS 308-309 are not limited to web servers.

Those of ordinary skill in the art will appreciate that the architecture and hardware depicted in FIG. 3 may vary.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of analyzing a performance of a display in a retail venue using image recognition analytics, the method comprising:
capturing an image of the display;
analyzing the image of the display against a defined set of image attributes;
generating a display classification for the display based on said analyzing; and
extracting information about a specified performance of the display using the display classification and an image analytics system.

2. The method according to claim 1, wherein specified products are held for sale on the display, and the extracting information about a specified performance of the display includes extracting information about the sales of the specified products on the display.

3. The method according to claim 2, wherein the extracting information about the sales of the specified products on the display includes correlating sales of the specified products on the display with one or more of the image attributes.

4. The method according to claim 3, wherein the one or more of the image attributes includes a location of the display in the retail venue.

5. The method according to claim 3, wherein the correlating sales of the specified products on the display with one or more of the image attributes includes determining a sensitivity of the sales of one of the products to a location of said one of the products on the display.

6. The method according to claim 3, wherein:
the analyzing the image of the display includes obtaining a specified measure of a defined appearance of the display; and
the one or more of the image attributes includes said defined appearance of the display.

7. The method according to claim 1, wherein the extracting information about a specified performance of the display includes using said information to determine when to re-stock the display.

8. The method according to claim 1, wherein the extracting information about a specified performance of the display includes correlating said specified performance with a location of the display in the retail venue.

9. The method according to claim 1, wherein the extracting information about a specified performance of the display includes comparing the specified performance of the display to given performances of other shelves.

10. The method according to claim 1, wherein the set of image attributes includes one or more of:
a lighting level of the display;
a texture of the display;
a density of promotional material on the display; and
a stocking level of the display.

11. A system for analyzing a performance of a display in a retail venue using image recognition analytics, the system comprising:
an imaging capturing device for capturing an image of the display;
an image analyzer for analyzing the image of the display against a defined set of image attributes, and for generating a display classification for the display based on said analyzing; and
an image analytics system for extracting information about a specified performance of the display using the display classification.

12. The system according to claim 11, wherein specified products are held for sale on the display, and the extracting information about a specified performance of the display includes extracting information about the sales of the specified products on the display.

13. The system according to claim 12, wherein the extracting information about the sales of the specified products on the display includes correlating sales of the specified products on the display with one or more of the image attributes.

14. The system according to claim 13, wherein the one or more of the image attributes includes a location of the display in the retail venue.

15. The system according to claim 13, wherein the correlating sales of the specified products on the display with one or more of the image attributes includes determining a sensitivity of the sales of one of the products to a location of said one of the products on the display.

16. A computer program product for analyzing a performance of a display in a retail venue using image recognition analytics, the computer program product comprising:
a computer readable storage medium having program instructions embodied therein, the program instructions executable by a computer to cause the computer to perform the method of:
receiving an image of the display;
analyzing the image of the display against a defined set of image attributes;
generating a display classification for the display based on said analyzing; and
extracting information about a specified performance of the display using the display classification and an image analytics system.

17. The computer program product according to claim 16, wherein specified products are held for sale on the display, and wherein:
the extracting information about a specified performance of the display includes correlating sales of the specified products on the display with one or more of the image attributes.

18. The computer program product according to claim 17, wherein:
the analyzing the image of the display includes obtaining a specified measure of a defined appearance of the display; and
the one or more of the image attributes includes said defined appearance of the display.

19. The computer program product according to claim 16, wherein the extracting information about a specified performance of the display includes using said information to determine when to re-stock the display.

20. The computer program product according to claim 16, wherein the extracting information about a specified performance of the display includes comparing the specified performance of the display to given performances of other shelves.
